(19) United States
(12) Patent Application Publication
(10) Pub. No.: US 2010/0218047 A1
(43) Pub. Date: Aug. 26, 2010

(54) METHOD AND DEVICE FOR ERROR MANAGEMENT

(76) Inventors: Philipp Woerz, Heilbronn (DE); Mathias Bieringer, Illingen (DE); Alexander Schaefer, Heilbronn (DE)

Correspondence Address: KENYON & KENYON LLP, ONE BROADWAY, NEW YORK, NY, 10004, US

(21) Appl. No.: 12/305,820

(22) PCT Filed: Sep. 20, 2007
(86) PCT No.: PCT/EP2007/059973

§ 371 Date: May 11, 2010

(30) Foreign Application Priority Data
Sep. 29, 2006 (DE) 10 2006 046 399.4

(51) Int. Cl. G06F 11/07

(52) U.S. Cl. 714/37; 714/E11.029

(57) ABSTRACT

A method for error management in a system having a plurality of components, error conditions of the components being able to be indicated by status values, includes a first status value being determined as a function of an error condition of a first component, and of a second status value being determined as a function of an error condition of a second component and as a function of the first status value.

### FIELD OF THE INVENTION

The present invention relates to a method for error management, a corresponding device, and to a corresponding computer program and a computer program product.

### BACKGROUND INFORMATION

DE 197 31 116 relates to a control device for a system. The system is equipped with sensors. Measured values of the sensors can be transmitted to the control device via connecting lines. In this manner the control system obtains information about states of the system.

DE 103 02 054 relates to the checking of components of an internal combustion engine. Each component is assigned a diagnosis function, which communicates with a central function via an individual interface.

In the following text, reference is made to an electronic stability program, which may be used in the automotive sector, for example. However, the method or the device is not restricted to this application.

The electronic stability program (ESP; ESP=electronic stability program) uses different hardware components. In this context, sensors, final control elements, data-transmission controllers and control device components of all types are subsumed under the term hardware components. The data transmission controllers may be CAN or Flex-Ray, for example. Counted among the control device components are ROM, RAM, EEPROM or A/D converters, for instance.

All of the mentioned hardware components as well as the signals transmitted or supplied by the hardware components are monitored during their operation in order to detect possible failures. An instantaneous state of a component or a signal is referred to as status. Possible statuses are, for example, “valid”, “briefly invalid”, “not initialized”, and “invalid”. A plurality of stages is possible under the status of “not initialized”.

Currently the statuses of individualized components are determined in decentralized manner by a multitude of monitoring algorithms. This means that the monitoring algorithms are distributed across the entire system, e.g., the ESP. The resulting statuses are likewise determined in distributed fashion, by complex logic elements. Also achieved in distributed fashion, i.e., implemented in a plurality of locations within the system, is a sequence-error prevention, by which non-causal errors are suppressed, as well as a multiple-error treatment.

This distribution of the tasks and responsibilities makes the product configuration of the system and the processing of customer projects much more difficult. Furthermore, the use of tools for the automatic document generation in the three addressed areas, the determination of the resulting statuses, the sequence-error prevention as well as the multiple-error treatment are not possible in conventional systems.

### SUMMARY

Example embodiments of the present invention provide a method as well as a device for better error management in a system having a plurality of components, as well as a corresponding computer program and a computer program product.

Example embodiments of the present invention provide a method for error management in a system having a plurality of components, in which error conditions of the components are able to be indicated by status values. A first status value is determined as a function of an error condition of a first component, and a second status value is determined as a function of an error condition of a second component and as a function of the first status value.

According to the method of example embodiments of the present invention, errors within an overall system are able to be detected, represented and communicated very rapidly within the entire system.

Moreover, example embodiments of the present invention provide a device for error management in a system having a plurality of components, the device executing all of the steps of the method according to example embodiments of the present invention.

The computer program having program-code according to example embodiments of the present invention is designed to implement all of the steps of the method according to example embodiments of the present invention when this computer program is executed on a computer or a corresponding computing unit, in particular a device according to example embodiments of the present invention.

The computer program product according to example embodiments of the present invention having program code stored on a computer-readable memory medium is provided for implementing the method according to example embodiments of the present invention when this computer program is executed on a computer or a corresponding computing unit, in particular on a device according to example embodiments of the present invention.

An aspect of example embodiments of the present invention is able to be represented in what is known as a failure dependency structure. The failure dependency structure includes and represents the dependencies among the individual monitored hardware components and signals of the system. Furthermore, the failure dependency structure includes an assignment of monitoring algorithms to the monitored hardware components.

Based on this, the approach according to example embodiments of the present invention allows a collection of all monitoring results available from components of the system, and it enables a determination of resulting statuses of hardware components and signals. Furthermore, sequence errors are able to be detected in order to suppress implausible error entries in the memory. Such a process is also known as sequence error prevention. In addition, the preparation of a multiple-error treatment is made possible.

The approach according to example embodiments of the present invention offers a number of advantages that are independent of the implementation. Among them is a central collection of all errors reported by monitoring algorithms. This vastly improves the transparency of the system. The dependencies that are illustrated in the failure dependency structure are heavily project-dependent. Because of the central definition of these dependencies, the outlay in the project initiation and during the course of the project is reduced considerably. The demands on the overall system usually change during the project development. The portion of the system and software components affected by these changes is very low. The centralization of the dependencies makes analyses much easier and involves considerably fewer people. A tool-based analysis of the implementation of the hardware dependencies is greatly simplified or made possible by the central definition of the dependencies. The product configuration is greatly facilitated. The error susceptibility is considerably reduced by the tool-based configuration.

Furthermore, the approach according to example embodiments of the present invention offers a number of implementation-relevant advantages. For example, very efficient algorithms may be used for the further processing of the errors. As a result, fewer of the very limited resources of ROM, RAM and run time or cycle time are used up in a control device. A graphic product configuration and automatic code generation reduce the error susceptibility and considerably simplify the product handling.

For practical purposes, the status values indicate whether a value able to be provided by a component is valid or invalid, and a second status value is able to be determined in such a way that the second status value indicates that a value able to be provided by the second component of the system is invalid if the first status value obtained from the first component of the system indicates that a value able to be provided by the first component is invalid. In this way status values are able to be communicated very rapidly within the system, which, in particular, also makes it possible to provide safety-relevant status values for all of the components within a system.

It may be provided that an additional status value is determined as a function of an error condition of the additional component and as a function of the first or a preceding status value.

According to the method according to example embodiments of the present invention, the system includes a virtual component, and an error condition of the virtual component is determined from status values of a predefined (real) component according to a linkage specification, and a virtual status value is determined as a function of the error condition of the virtual component and as a function of the first status value. By defining such virtual components and correspondingly useful linkage specifications, error conditions are able to be communicated within the system in an especially effective manner.

It may be provided that each status value whose determination depends on a preceding status value is determined only once on the basis of the first status value. As a result of this measure it is possible to save resources within the system without detrimental effect on the reliability or safety of the system.

Furthermore, it is advantageous that a status value as a function of which no further status value is determined, is analyzed in order to determine which status value, starting out from the first status value, has first indicated that a value able to be supplied by a component is invalid, in order to determine a faulty component in this manner. It is may be provided in this context that a part of the system that has the faulty component is degraded or deactivated. This ensures an optimal operation, in particular, also of safety-relevant systems notwithstanding the faulty component.

Information about the faulty component is expediently stored, which facilitates servicing or error-analysis operations.

It is advantageous that the error conditions of the components are determined by implementing monitoring algorithms. Such monitoring algorithms are able to be used in an especially effective and rapid manner on the basis of a method according to example embodiments of the present invention.

In an advantageous manner, the linkage specification for determining the error condition of a virtual component is an AND-linkage. An error search is able to be carried out in an especially effective manner with the aid of this linkage.

It may be provided that the status values also indicate whether a value able to be provided by a component is briefly invalid or whether a component is not initialized; the second status value is able to be determined in such a way that it indicates that a value able to be provided by the second component is invalid if a first status value indicates that a value able to be provided by a first component is briefly invalid or that the first component is not initialized. Short-term malfunctions of components, in particular, are also able to be taken into account by these measures.

Additional advantages and developments of example embodiments of the present invention are described in the specification and the appended figures.

It is understood that the aforementioned features and the features still to be discussed in the following text may be used not only in the indicated combination but also in other combinations or by themselves.

Example embodiments of the present invention are schematically illustrated in the following figures and described in detail in the following text with reference to the drawing.

### BRIEF DESCRIPTION OF THE DRAWINGS

FIG. 1 shows a failure dependency structure according to a an example embodiment of the present invention; and

FIG. 2 shows an additional failure dependency structure according to an example embodiment of the present invention.

### DETAILED DESCRIPTION

The method according to example embodiments of the present invention and the device according to example embodiments of the present invention are able to be represented in the form of a failure dependency structure. The failure dependency structure illustrates a system having a plurality of components. The failure dependency structure includes all monitored components of the system. Counted among these are, for one, all hardware components of the system and also the signals provided by the hardware components. The monitored components are represented by nodes in the failure dependency structure. Dependencies among the components are shown by connections between the nodes in the failure dependency structure.

The failure dependency structure is directional and anti-cyclical. Directional means that a connection between two nodes of the failure dependency structures is always passed through in only one direction in each case. If one follows random connections starting from any one of the nodes, then one neither returns to the starting node nor does one pass through one of the other nodes more than once. That is to say, the failure dependency structure is anti-cyclical.

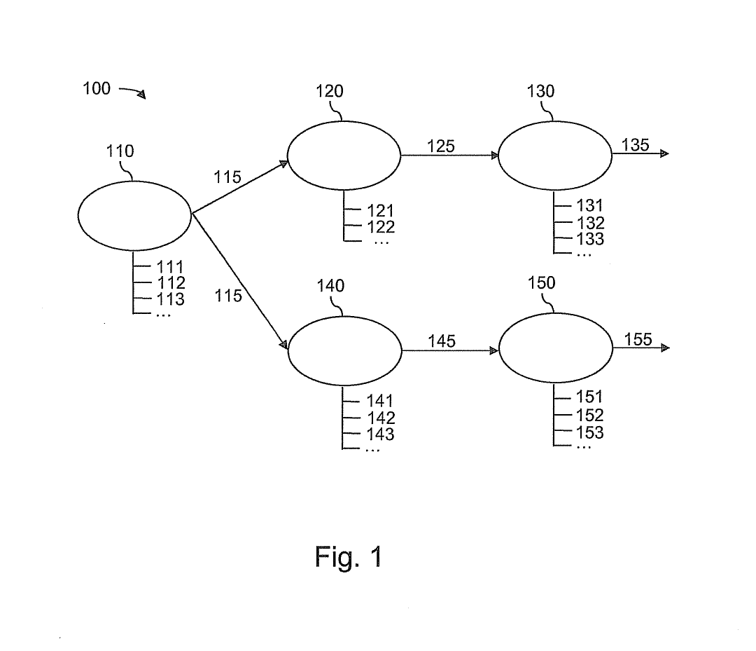

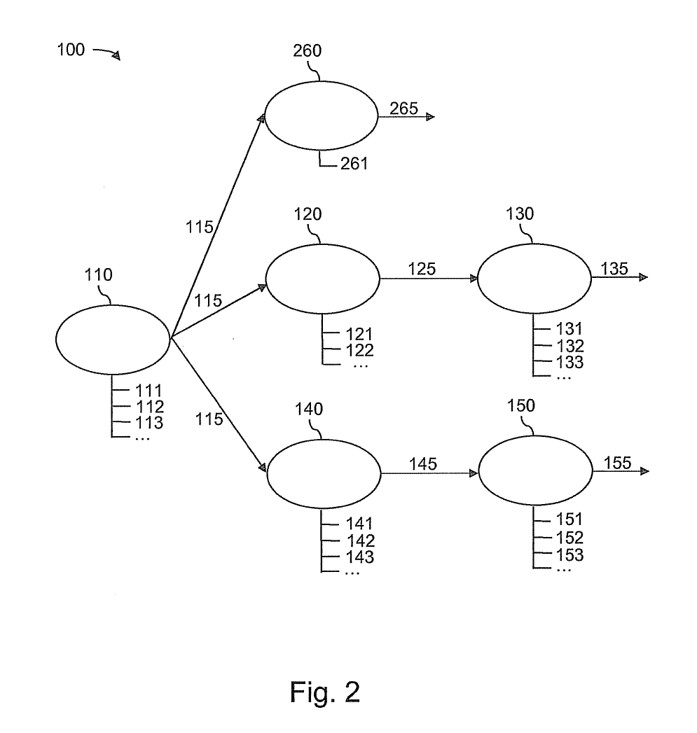

The FIGS. 1 and 2 illustrate failure dependency structures according to exemplary embodiments of the present invention. The nodes of the illustrated failure dependency structures are shown as ellipses with directional connections between them. Also shown are monitors assigned to the individual nodes, which may be prioritized among each other.

FIG. 1 shows a failure dependency structure according to an exemplary embodiment of the present invention. The failure dependency structure represents a system 100 having a plurality of components.

An error condition or availability condition of a first monitored component 110 of system 100 is able to be determined with the aid of one or a plurality of monitoring algorithms 111, 112, 113. A first status value 115 may be determined as a function of the error condition of first component 110 and transmitted or made available to a second component 120. Component 110 may be designed to supply a component value during operation. The component value could be a sensor signal, a control signal or a transmitted value, for instance. The component value able to be supplied, e.g., the sensor signal, may be valid or invalid as a function of the error condition of component 110. According to one exemplary embodiment, first status value 115 may indicate whether the value able to be supplied by first component 110 is valid or invalid.

An error condition of second component 120 of system 100 is able to be determined with the aid of one or a plurality of additional monitoring algorithms 121, 122. A second status value 125 may be determined and made available as a function of the error condition of second component 120 and as a function of first status value 115, which is supplied by the first component. Second status value 125 may indicate whether a value able to be supplied by second component 120 is valid or invalid. By determining second status value 125 also as a function of first status value 115, second status value 125 can be determined in such a way that second status value 125 indicates that a value able to be supplied by second component 120 is invalid if first status value 115 indicates that a value able to be supplied by first component 110 is invalid. In other words, second status value 125 is determined in such a way that second status value 125 can indicate that a value able to be supplied by second component 120 is valid only if first status value 115 indicates that a value able to be supplied by first component 115 is valid.

An error condition of a third component 130 of system 100 is able to be determined with the aid of one or a plurality of monitoring algorithms 131, 132, 133. A third status value 135 is able to be determined and made available as a function of the error condition of third component 130 and as a function of second status value 125. Third status value 135 can indicate that a value able to be supplied by third component 130 is valid or invalid. By determining third status value 135 as a function of second status value 125, third status value 135 is able to be determined such that third status value 135 indicates that a value able to be supplied by third component 130 is invalid if second status value 125 indicates that a value able to be supplied by second component 120 is invalid.

According to the exemplary embodiment shown in FIG. 1, system 100 has an additional second component 140 and an additional third component 150, which are disposed in parallel with first and second components 120, 130, respectively. First status value 115 is additionally made available to additional second component 140.

An error condition of second additional component 140 of system 100 is able to be determined with the aid of a plurality of monitoring algorithms 141, 142, 143. A second additional status value 145 is able to be determined and made available as a function of the error condition of second additional component 140 and as a function of first status value 115, which is made available by the first component. Second additional status value 145 may indicate whether a value able to be supplied by second additional component 140 is valid or invalid. By determining second additional status value 145 as a function of first status value 115, it is possible to determine second additional status value 145 in such a way that second additional status value 145 indicates that a value made available by second additional component 140 is invalid if first status value 115 indicates that a value able to be supplied by first component 110 is invalid.

An error condition of a third additional component 150 of system 100 is able to be determined with the aid of a plurality of monitoring algorithms 151, 152, 153. A third additional status value 155 is able to be determined and made available as a function of the error condition of third additional component 150 and as a function of second additional status value 145. Third additional status value 155 may indicate whether a value supplied by third additional component 150 is valid or invalid. By determining third status value 155 as a function of second additional status value 145, third status value 155 is able to be determined such that third status value 155 indicates that a value able to be supplied by third additional component 150 is invalid if second additional status value 145 indicates that a value able to be supplied by second additional component 140 is invalid.

According to an exemplary embodiment, a status value whose determination depends on a preceding status value, is determined only when the preceding status value has been determined. For example, first status value 115 is determined first. Then second status value 125 is determined as a function of first status value 115 and the error condition of second component 120. Subsequently, third status value 135 is determined as a function of second status value 125 and the error condition of third component 130. The method for error management according to example embodiments of the present invention can be executed multiple times and as often as desired in succession over time. Each status value 115, 125, 135, 145, 155 is determined only once in each execution, or each status value needs to be determined only once.

According to an exemplary embodiment, status values 135, 155 as a function of which no further status value is determined (but also all other status values) may be evaluated in order to detect a malfunctioning component of the system. This may be done, for example, with the aid of an evaluation device (not shown in the figures), which is designed to receive and evaluate status values 135, 155. In the process it is possible to determine whether, and if so, which status value has first indicated that a value able to be supplied by a component is invalid. A part of system 100 having the malfunctioning component can then be degraded or deactivated. It is also possible to store an item of information about the malfunctioning component, for example in a memory device (not shown in the figures).

According to an exemplary embodiment, the status values may further indicate whether a value able to be provided by a component is briefly invalid or whether a component is not initialized. If, for example, second status value 125 indicates that a value able to be supplied by second component 120 is briefly invalid or that second component 120 is not initialized, then third status value 135 is unable to indicate that a value able to be supplied by third component 130 is valid, but instead indicates that the value able to be provided by third component 130 is likewise invalid.

System 100 may be an ESP, for example. Components 110, 120, 130, 140, 150 may be sensors, actuators, data-transmission controllers, control-device components or signals transmittable by such components, for example. The status values may be provided in any form, e.g., in the form of signals, which are able to be received by the dependent components.

Node 110, for example, may be assigned to a control device ECU, node 120 to an A/D converter, node 130 to a wheel-speed sensor VL, node 140 to a CAN, and node 150 to a yaw-rate sensor. Monitoring of total failure 111, monitoring of ROM 112, and monitoring of RAM 113, among others, are assigned to node 110. Monitoring of a total failure 121 and monitoring of interference 122, among others, are able to be assigned to node 120. Monitoring of a total failure 131, monitoring of a gradient 132, and monitoring of a value range 133, among others, may be assigned to node 130. Monitoring of a total failure 141, monitoring of a message “1” 142, and monitoring of a message “2” 143, among others, may be assigned to node 140. Monitoring of a total failure 151, monitoring of a gradient 152, and monitoring of a value range 153, among others, may be assigned to node 150.

With the aid of the basic representation of the failure dependency structure, the following text describes the way in which the tasks of determining the resulting hardware and software statuses, a sequence-error prevention as well as a preparation of a multiple-error treatment are able to be realized using the approach according to example embodiments of the present invention.

The determination of the resulting hardware and software statuses is discussed first. There are two influencing factors in the determination of a resulting node status. These are, for one, the results of the node's own monitoring, and for another, the statuses of the preceding nodes. If a monitoring algorithm detects an error, then the associated node is marked invalid. In the same manner, all so-called children of this node, i.e., all nodes that are reachable by following the connections starting from this node, are likewise invalid. This inheriting of the detected errors by the so-called child nodes is referred to as error propagation. This is necessary because none of the signals supplied by the failed hardware component can be used any longer.

For example, in a particular project a connection of the yaw-rate sensor to which node 150 is assigned, is realized by the CAN protocol, to which node 140 has been assigned. If the failure of the CAN controller is detected by the node's own monitoring, total failure 141, then node 140, which is assigned to the CAN, is marked invalid. Because the correct reception of signals of the CAN is no longer ensured, node 150, which is assigned to the yaw rate, is likewise automatically marked invalid. That is to say, an error propagation takes place.

Now the sequence-error prevention is discussed. When an error was detected in a monitored component, an entry in an error memory (not shown in the figures) takes place in order to be able to reconstruct the error event. This error memory can be analyzed at a later date, for example by service technicians in a service facility. To allow a predictable and uncomplicated localization of the defective component—this falls under the keyword of “smallest exchangeable unit”—the error memory must include only causal errors and no sequence errors, if possible. A causal error is the particular error that provided the actual reason for a malfunction. A sequence error is an error that is detected on the basis of another error.

To clarify, it may be said that, for the determination of valid signals, errors must be propagated as described above with reference to the determination of the resulting hardware and signal statuses. However, when filling the error memory, errors must be filtered out.

For the following examples it is assumed that a dependent signal, such as of the yaw rate (in 150) supplies errors if the previous signal or the previous component, e.g., the CAN (in 140), is defective.

Referring to FIG. 1, the following scenario illustrates a simple example of a sequence error within node 130. A connection to a wheel-speed sensor of a vehicle is interrupted. A torn cable occurs, for example, which is detected by the node's own monitoring, total malfunction 131. This causes the measured wheel speed to drop abruptly from 50 m/s to 0 m/s within 10 ms. The gradient of the signal resulting therefrom of −5.000 m/s2 is detected as implausible (gradient monitoring 132). The actual cause of the excessively high gradient, however, is the line rupture.

However, sequence errors may also occur at different nodes that are dependent upon each other. With reference to FIG. 1, the following scenario illustrates an example for a sequence error at different nodes. For instance, interference of the A/D converter (120) occurs, which is detected by the monitoring of interference (in 122). Furthermore, the monitoring of the wheel-speed sensor (in 130) detects an invalid value (in 133) because the valid value range was left on account of the interference. The exceeding of permitted value range 133 therefore is a sequence error of the interference at A/D converter 122.

However, sequence errors may also occur before the causal error. For example, the CAN controller fails, so that the yaw-rate signal transmitted by the CAN very rapidly drops to the value of 0. The required time for detecting the failure of the CAN controller is considerably greater than the time for detecting the gradient error. This makes it possible that the sequence error “faulty gradient of the yaw rate”, which is detected by corresponding monitoring 152 at node yaw rate 150, occurs earlier than the causal error “failure of the CAN controller”, which is detected by corresponding monitoring 141 at node CAN 140.

FIG. 2 shows a failure dependency structure, which describes an additional exemplary embodiment of the present invention. According to this exemplary embodiment, system 100 already described with reference to FIG. 1 is expanded by a virtual component 260. Virtual component 260 is not a real component, but a virtual component which is included in the failure dependency structures in order to improve the error detection in system 100.

An error condition of virtual component 260 can also be determined with the aid of a monitoring algorithm 261. The monitoring algorithm may link status values of a predefined selection of components 110, 120, 130, 140, 150 of system 100 according to a linkage specification in order to determine the error condition of virtual component 260. For example, monitoring algorithm 261 could link status value 135 of third component 130 with additional second status value 145 of additional second component 140. The linkage specification may be an AND operation. A virtual status value 265 is determined as a function of the error condition of the virtual component and, according to the exemplary embodiment shown in FIG. 2, as a function of first status value 115.

Virtual component 260 is assigned a node 260 of the failure dependency structure. For example, a virtual hardware component “3 wheel speeds” or “3 wheel-speed sensors” may be assigned to node 260. In this case, node 260 may have monitoring 261 in the form of a number of defective wheel speeds.

Now, the preparation of a multiple-error treatment is discussed. As already mentioned, hardware components are monitored during the ongoing operation, and in the event of a detected error their statuses are set accordingly. These statuses may be used by downstream functionalities to degrade or deactivate parts of the system, e.g., the ESP, that use these hardware components. Degradation is understood as the switchover between different algorithms within a functionality from a high to a lower quality, e.g., the switchover from the use of measured variables to the use of estimated variables. Because of this so-called error treatment, a malfunction of the overall system due to faulty hardware components is avoided.

In the event that several errors occur one after the other or simultaneously, what is known as simple multiple-error treatment must be implemented. In the standard case, the individual target-system states are compared in the process and the one in which none of the failed hardware components is used is selected as new target-system state. The statuses of the individual hardware components are ascertained as basis.

In a few error combinations the availability of the hardware components is restricted such that instead of the just described simple multiple-error treatment, an expanded multiple-error treatment must be carried out. In the process, partial systems that are still able to operate using estimated variables following the simple multiple-error treatment are deactivated as well.

To simplify the further processing of the detected error, simple errors and multiple errors should use the same interface. To satisfy this requirement, it is known to form what is known as virtual hardware components. Signal statuses of the virtual hardware components are formed by a logical “AND” operation of individual statuses of other hardware components.

For instance, if system 100 represents an ESP and if the yaw-rate sensor, for example, which is assigned to node 150, fails in the ESP, then the status of the yaw-rate sensor is set to “invalid” as described above in connection with the determination of the resulting hardware and signal statuses. If the rotational-speed sensor additionally fails at one of the wheels, then its status is likewise set to “invalid”. If, as in the exemplary embodiment shown in FIG. 1, no virtual hardware component exists for this error combination, then a target system state is determined only on the basis of the two individual statuses.

If the rotational-speed sensor at one of the wheels fails in the ESP, then its status is set to “invalid”. If the rotational-speed sensors at two additional wheels fail in addition, then the ESP no longer has enough information available for safe operation. Therefore, the signal status of the virtual hardware component 260, “2 wheel-speed sensors”, is set to “invalid”. This information is utilized by downstream functionalities in order to deactivate the ESP notwithstanding the fact that the vehicle speed theoretically could still be calculated, albeit at a lesser quality.

The exemplary embodiments described with the aid of the figures are selected as examples. Depending on a system to be realized, components, additional components and virtual components may be disposed in any random number and, within the scope of a directional failure dependency structure, in any linkage among each other.

Example embodiments of the present invention are able to be implemented in the form of software. The method according to example embodiments of the present invention addresses configuring hardware dependencies of dynamic systems. Example embodiments of the present invention address a failure dependency structure is suitable for the central error administration in dynamic systems. The approach according to example embodiments of the present invention is by no means limited to the described electronic stability program ESP. Instead, the use in all mechatronically embedded systems is possible. The described examples from the ESP field are merely used for explanatory purposes, but do not restrict the application field of example embodiments of the present invention in any manner.

1-16. (canceled)

17. A method for error management in a system having a plurality of components, error conditions of the components being able to be indicated by status values, comprising:
determining a first status value as a function of an error condition of a first component; and
determining a second status value as a function of an error condition of a second component and as a function of the first status value.

18. The method according to claim 17, wherein the status values indicate whether a value able to be provided by a component is valid or invalid, and the second status value is determined such that the second status value indicates that a value able to be supplied by the second component is invalid if the first status value indicates that a value able to be supplied by the first component is invalid.

19. The method according to claim 17, wherein an additional status value is determined as a function of an error condition of an additional component and as a function of the first status value.

20. The method according to claim 17, wherein the system includes a virtual component, and an error condition of the virtual component is determined from status values of a predefined number of the components according to a linkage specification, and a virtual status value is determined as a function of the error condition of the virtual component and as a function of the first status value.

21. The method according to claim 17, wherein, starting from the first status value, each status value whose determination is a function of a preceding status value, is determined only once.

22. The method according to claim 17, wherein a status value as a function of which no further status value is determined, is evaluated in order to determine which status value, starting from the first status value, first indicated that a value able to be provided by a component is invalid, in order to determine a faulty component.

23. The method according to claim 22, wherein a part of the system that has the faulty component is at least one of (a) degraded and (b) deactivated.

24. The method according to claim 22, wherein information about the faulty component is stored.

25. The method according to claim 17, wherein the error conditions of the components are determined by implementing monitoring algorithms.

26. The method according to claim 20, wherein the linking specification for determining the error condition of the virtual component is an AND operation.

27. The method according to claim 18, wherein the status values also indicate at least one of (a) whether a value able to be provided by a component is briefly invalid and (b) whether a component is not initialized, the second status value being determined such that the second status value indicates that a value able to be provided by the second component is invalid if the first status value indicates at least one of (a) that the value able to be provided by the first component is briefly invalid and (b) that the first component is not initialized.

28. A device, comprising:
an arrangement adapted perform a method for error management in a system having a plurality of components, error conditions of the components being able to be indicated by status values, the method including:
determining a first status value as a function of an error condition of a first component; and
determining a second status value as a function of an error condition of a second component and as a function of the first status value

29. The device according to claim 28, wherein the components include at least one of (a) sensors, (b) actuators, (c) data-transmission controllers, (d) control-device components, and (e) signals transmittable by at least one of (i) sensors, (ii) actuators, (iii) data-transmission controllers, and (iv) control-device components

30. The device according to claim 28, wherein the system is a mechatronically embedded system.
